(19) United States
(12) Patent Application Publication
(10) Pub. No.: US 2015/0156064 A1
(43) Pub. Date: Jun. 4, 2015

(54) HOME ELECTRONIC DEVICE, METHOD FOR CONTROLLING THE HOME ELECTRONIC DEVICE, AND HOME ELECTRONIC NETWORKING SYSTEM

(71) Applicants: INVENTEC CORPORATION, TAIPEI CITY (TW); INVENTEC (PUDONG) TECHNOLOGY CORPORATION, SHANGHAI (CN)

(72) Inventor: MING-HUA LEE, Taipei City (TW)

(73) Assignees: INVENTEC CORPORATION, TAIPEI CITY (TW); INVENTEC (PUDONG) TECHNOLOGY CORPORATION, SHANGHAI (CN)

(21) Appl. No.: 14/227,856

(22) Filed: Mar. 27, 2014

(30) Foreign Application Priority Data
Nov. 29, 2013 (CN) 201310631697.8

(51) Int. Cl. H04L 12/24

(52) U.S. Cl. CPC H04L 41/0806

(57) ABSTRACT

The disclosure provides a home electronic device, a method for controlling the same, and a home electronic network system which includes a networking device, at least one home electronic device and a master electronic device. The networking device is configured to connect the internet. The at least one home electronic device is wire or wireless connected to the networking device. The master electronic device is also wire or wireless connected to the networking device and is configured to receive a set instruction via the networking device and control a targeting electronic device. The targeting electronic device is among the at least one home electronic device and the master electronic device and is determined according to the set instruction.

### CROSS-REFERENCE TO RELATED APPLICATIONS

This non-provisional application claims priority under 35 U.S.C. §119(a) on Patent Application No(s). 201310631697.8 filed in China on Nov. 29th, 2013, the entire contents of which are hereby incorporated by reference.

### BACKGROUND OF THE INVENTION

1. Technical Field of the Invention

This disclosure relates to a home electronic device, a home electronic device control method, and a home electronic networking system, and more particularly to a control method that controls a home electronic device in a home electronic networking system.

2. Description of the Related Art

With the development of technology, home appliances are constantly getting more convenient with better functions. Some may provide information about the status of the machines; some may automatically adjust the settings according to the user's habits. The features on these home appliances may be complicated and different from one another, so it is hard to manage all the home appliances together as one through the “home appliances cloud” concept.

### SUMMARY OF THE INVENTION

The home electronic device of the disclosure comprises a storage module, a communication module and a execution module. The storage module is configured to store a setup-information of the home electronic device. The communication module is configured to selectively connect to a networking device and selectively receive a command or send the setup-information through the networking device. The execution module is electrically connected to the storage module and the communication module. The execution module is configured to operate according to the setup-information and adjust the setup-information according to the command.

The home electronic device control method of the disclosure comprises the following steps. A first home electronic device is connected to a network. Whether a master electronic device exists in the network is determined. When the master electronic device exists, a first setup-information of the first home electronic device is sent to the master electronic device, a first setup-parameter sent by the master electronic device is received, and then the first setup-parameter sent by the master electronic device is operated. When the master electronic device does not exist, the first home electronic device is set as the master electronic device, a second setup-information of a second home electronic device is received. When a second setup-parameter is received, the second setup-parameter is sent to the second home electronic device.

The home electronic networking system of the disclosure comprises a network device, at least a home electronic device, and a master electronic device. The network device is configured to connect with the internet. The home electronic device is electrically connected to the network device wired or wirelessly. The master electronic device is electrically connected to the network device wired or wirelessly. The master electronic device is configured to receive a setup-command from the internet through the network device, to find a target electronic device corresponding to the setup-command from the group consisting of the at least one home electronic device and the master electronic device, and to control the target electronic device according to the setup-command through the network device.

### BRIEF DESCRIPTION OF THE DRAWINGS

The present disclosure will become more fully understood from the detailed description given hereinbelow, along with the accompanying drawings which are for illustration only, thus are not limitative of the present disclosure, and wherein:

FIG. 1 is a function diagram of a home electronic device in an embodiment in the disclosure;

FIG. 2 is a flow chart of a home electronic device control method in an embodiment in the disclosure;

FIGS. 3A to 3C are diagrams of a home electronic networking operation in an embodiment in the disclosure; and

FIG. 4 is a diagram of a home electronic networking system in an embodiment in the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

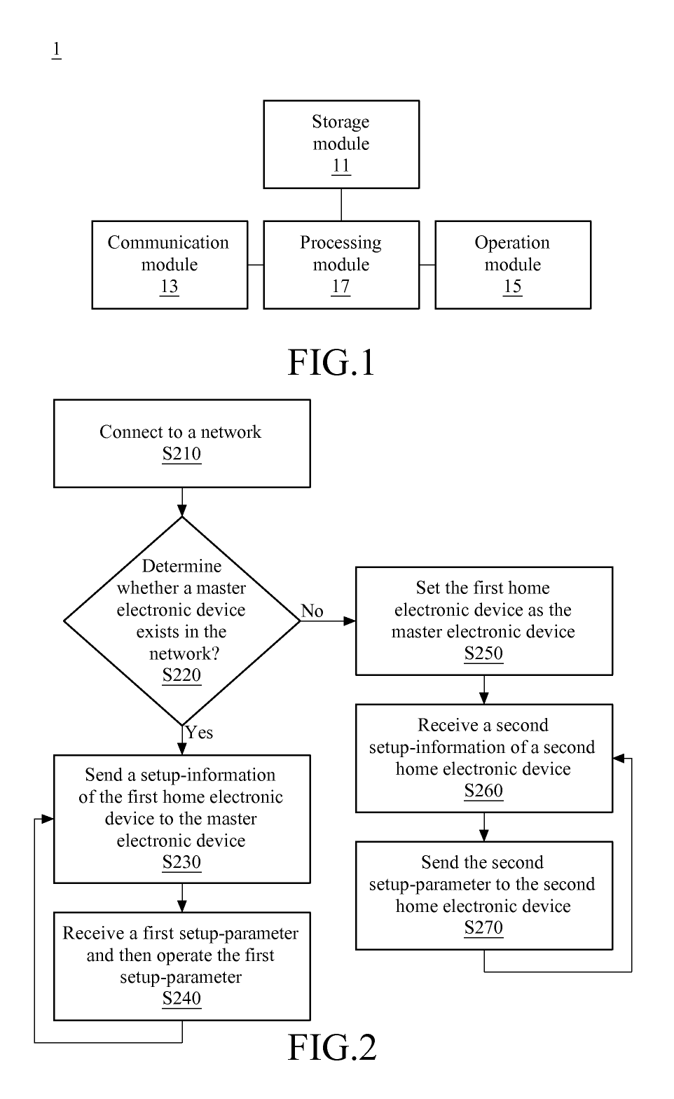

Referring to FIG. 1, which is a function diagram of a home electronic device in an embodiment in the disclosure. As shown in FIG. 1, the home electronic device 1 comprises a storage module 11, a communication module 13, an operation module 15, and a processing module 17. The processing module 17 is electrically connected to the storage module 11, the communication module 13, and the operation module 15.

The storage module 11 is configured to store a setup-information of the home electronic device 1. The setup-information comprises the network address of the home electronic device 1, the name information of the home electronic device 1, parameters of the home electronic device 1, and operable actions of the home electronic device 1. For example, if the home electronic device 1 is an air-conditioner, the name information for the home electronic device 1 may be the default name information of the manufacturer, or can be named by users, such as bedroom air-conditioner. The parameters of the home electronic device 1 may include pre-set on/off time, current temperature, wind direction, wind speed, and other information about the device. The operable actions of the home electronic device 1 may include air-conditioning mode, dehumidifier mode, air-supply mode, and other probable actions of the device. The storage module may be a static random access memory (SRAM), dynamic random access memory (DRAM), Flash Memory, hard disk drive (HDD), and other probable storage method for the device. However, the disclosure is not limited thereto.

The communication module 13 is configured to selectively connect to a networking device and selectively receive a command or send the setup-information through the networking device. For example, the network device may be a router, an internet protocol (IP) address router, or other probable device. The communication module 13 may be a network interface controller (NIC) that connects with the network device wired or wirelessly.

The operation module 15 is configured to operate according to the setup-information. For example, if the home electronic device 1 is an air-conditioner, then the operation module 15 operates according to the setup-information in the storage module 11 such as turning on/off, changing the temperature, or changing the wind direction.

The processing module 17 is configured to adjust the setup-information according to the command. For example, if the command is to change the temperature of the home electronic device 1 (air-conditioner) to 27 degrees Celsius, the processing module 17 overwrites the temperature parameter in the storage module 11 with 27 degrees Celsius. According to the embodiment, the processing module 17 may be an embedded processor, a central processing unit (CPU), a Programmable Logic Array (PLA), or other suitable device, but the disclosure is not limited thereto.

According to another embodiment, the operation module 15 and the processing module 17 may be integrated into a execution module (not shown), i.e. the execution module is electrically connected to the storage module 11 and the communication module 13 and is configured to operate according to the setup-information and to adjust the setup-information according to the command. According to the embodiment, the execution module may be an embedded processor, a central processing unit (CPU), a Programmable Logic Array (PLA), or other suitable device, but the disclosure is not limited thereto.

According to an embodiment, when the communication module 13 is connected to the networking device, the processing module 17 determines whether the networking device is connected to a master electronic device or not. When the networking device is not connected to the master electronic device, the processing module 17 sets the home electronic device as the master electronic device. When the networking device is connected to the master electronic device, the processing module 17 sends the setup-information to the master electronic device through the networking device. The master electronic device is able to collect the setup-information of the home electronic devices that are connected to the network device, so when the network device receives a command and sends the command to the master electronic device, the master electronic device may correctly send the command to the corresponding home electronic device.

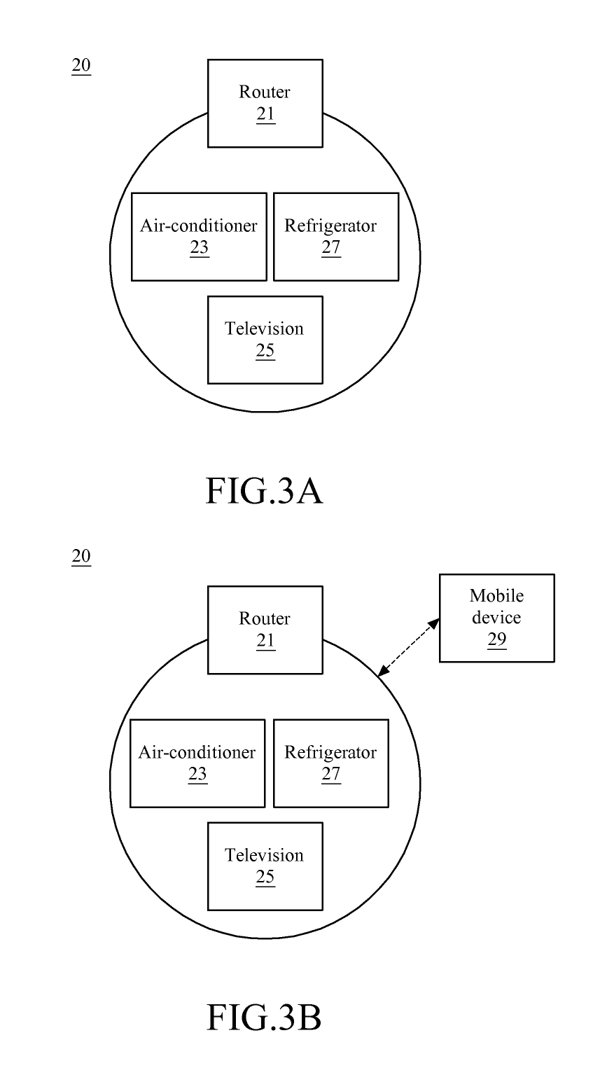

Referring to FIG. 2, which is a flow chart of a home electronic device control method in an embodiment in the disclosure. The home electronic device control method is described as follows. First, the first home electronic device is connected to the network (Step S210). As shown in Step S220, the first home electronic device may first determine whether a master electronic device exists in the network. If the master electronic device exists, a first setup-information of the first home electronic device is sent to the master electronic device (Step S230). A first setup-parameter sent by the master electronic device is received and operated (Step S240), and then returns to Step S230. If the master electronic device does not exist, the first home electronic device is set as the master electronic device (Step S250) and a second setup-information of a second home electronic device is received (Step S260). When a second setup-parameter is received, then the second setup-parameter is sent to the second home electronic device (Step S270).

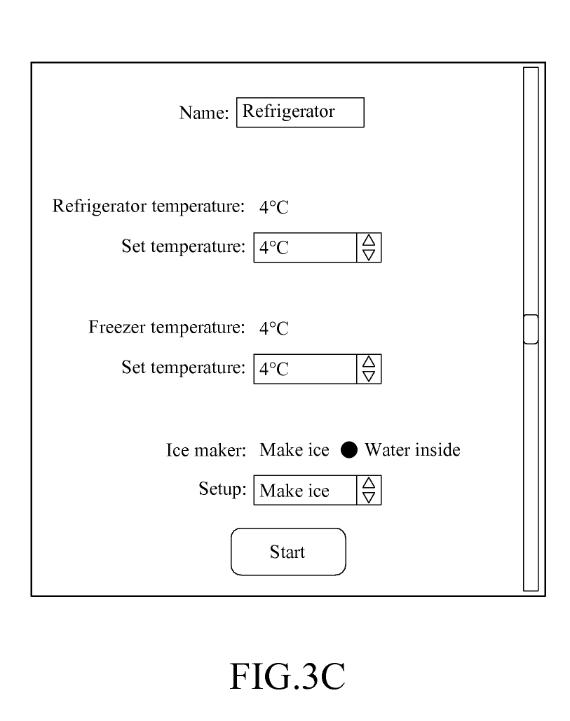

Referring to FIGS. 3A to 3C, FIGS. 3A to 3C are diagrams of a home electronic networking operation in an embodiment in the disclosure. As shown in FIG. 3A, the home electronic networking system 20 has already contained a network device router 21 and two home electronic devices: air-conditioner 23 and television 25, and the air-conditioner 23 is the master electronic device of this home electronic networking system 20. When the home electronic networking system 20 is added with a new refrigerator 27, the refrigerator 27 first finds out that there is already a master electronic device existed, and then sends out the setup-information (for refrigerator 27, the setup-information includes current temperature, setting temperature, making ice function) to the air-conditioner 23. The air-conditioner 23 may store the information about the refrigerator 27 (the network address, setup-information of the refrigerator 27), and upload the information to the internet through the router 21 for users to observe the status of the home electronic devices and perform further actions.

As shown in FIG. 3B, the user may use a mobile device 29 to connect to the home electronic networking system 20 and receive the setup-information of all the electronic devices provided by the air-conditioner 23. As shown in FIG. 3C, the user may observe the parameters (such as the temperature) of the refrigerator 27 and perform actions (such as reset the temperature) through the user interface on the mobile device 29. The mobile device 29 will then send the updated parameters to the air-conditioner 23. When the air-conditioner 23 receives the new parameters, the air-conditioner 23 directs the corresponding new parameters to the refrigerator 27. The refrigerator 27 then performs the actions that correspond to the new parameters and sends the new setup-information to the air-conditioner 23.

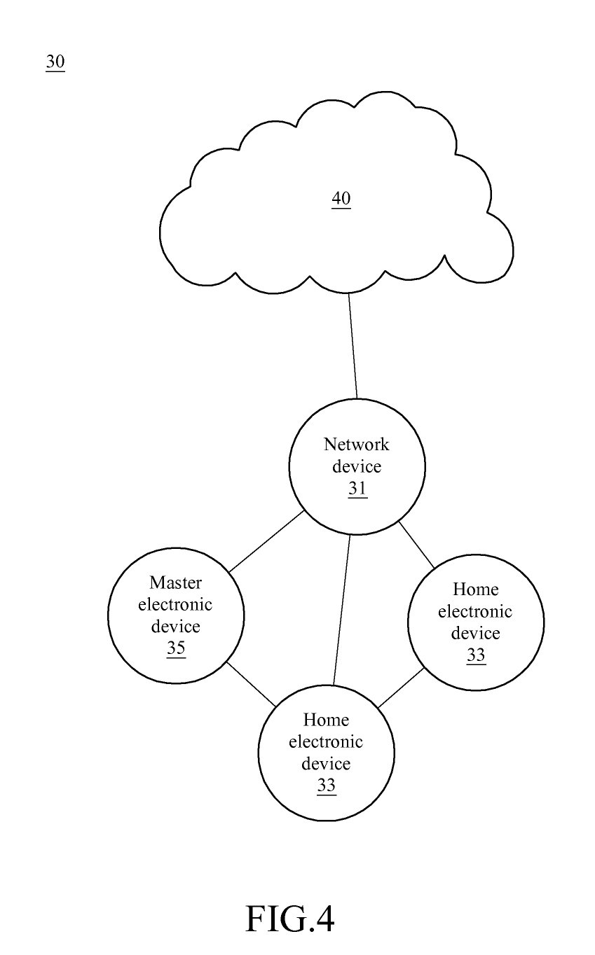

Referring to FIG. 4, which 4 is a diagram of a home electronic networking system in an embodiment in the disclosure. As shown in FIG. 4, the home electronic networking system 30 comprises a network device 31, at least one home electronic device 33, and a master electronic device 35. The network device 31 is configured to connect to the internet 40.

The home electronic device 33 and the master electronic device 35 are electrically connected with the network device 31, wired or wirelessly. In this embodiment, the master electronic device 35 is configured to receive a setup-command from the internet through the network device, to find a target electronic device corresponding to the setup-command from a group of devices consisting of at least one home electronic device 33 (e.g., the number is two in FIG. 4) and the master electronic device 35, and to control the target electronic device according to the setup-command through the network device.

According to an embodiment, the home electronic device 33 sends the setup-information corresponding to the home electronic device 33 to the master electronic device 35 through the network device 31. According to another embodiment, the home electronic device 33 directly sends the corresponding setup-information to the master electronic device 35. The master electronic device 35 then sends one or more of the setup-information, corresponding to the home electronic device 33 and the master electronic device 35, to the internet 40 through the network device 31. Thus, the user may then observe the status of the devices and further controls the devices in the home electronic networking system 30 through the internet 40.

According to an embodiment (not shown), the network device 31 is one of the master electronic device 35 and the home electronic device 33, i.e. one of the master electronic device 35 and the home electronic device 33 is a network router configured to connect with the internet.

According to the home electronic device, the home electronic device control method, and the home electronic networking system of the disclosure, at least one home electronic device collects the setup-information of the several home electronic devices in the local area network and sends the setup-information to the internet through the network device (Router). The user may receive the setup-information and respond the setup-information by sending out commands to the home electronic devices. When the command enters anyone of the home electronic devices, the home electronic device may determine the home electronic device corresponding to the command and control the home electronic device correspondingly.

What is claimed is:

1. A home electronic device, comprising:
a storage module, configured to store a setup-information of the home electronic device;
a communication module, configured to selectively connect to a networking device and selectively receive a command or send the setup-information through the networking device;
a execution module, electrically connected to the storage module and the communication module, and configured to operate according to the setup-information and adjust the setup-information according to the command.

2. The home electronic device according to claim 1, wherein the execution module further comprises an operation module and a processing module;
the operation module, configured to operate according to the setup-information; and
the processing module, electrically connected to the storage module, the communication module, and the operation module, and configured to adjust the setup-information according to the command.

3. The home electronic device according to claim 1, wherein when the communication module is connected to the networking device, the processing module determines whether the networking device is connected to a master electronic device or not, when the networking device is not connected to the master electronic device, the processing module sets the home electronic device as the master electronic device, and when the networking device is connected to the master electronic device, the processing module sends the setup-information to the master electronic device through the networking device.

4. The home electronic device according to claim 1, wherein the setup-information comprises:
a network address;
a name information;
at least a parameter, configured to describe the status of the home electronic device; and
an operable action.

5. A home electronic device control method, comprising:
connecting a first home electronic device to a network;
determining whether a master electronic device exists in the network;
when the master electronic device exists, sending a first setup-information of the first home electronic device to the master electronic device, receiving a first setup-parameter sent by the master electronic device, and then operating the first setup-parameter sent by the master electronic device; and
when the master electronic device does not exist, setting the first home electronic device as the master electronic device, receiving a second setup-information of a second home electronic device, and when a second setup-parameter is received, sending the second setup-parameter to the second home electronic device.

6. The home electronic device control method according to claim 5, wherein each of the first setup-information and the second setup-information comprises:
a network address;
a name information;
at least a parameter, configured to describe the status of the home electronic device corresponding to the parameter; and
an operable action.

7. A home electronic networking system, comprising:
a network device, configured to connect with the internet;
at least one home electronic device, wired or wirelessly, electrically connected to the network device; and
a master electronic device, wired or wirelessly, electrically connected to the network device, and configured to receive a setup-command from the internet through the network device, to find a target electronic device corresponding to the setup-command from the group consisting of the at least one home electronic device and the master electronic device, and to control the target electronic device according to the setup-command through the network device.

8. The home electronic networking system according to claim 7, wherein each of the home electronic devices sends a setup-information corresponding to the home electronic devices to the master electronic device through the network device.

9. The home electronic networking system according to claim 8, wherein the master electronic device sends the setup-information, corresponding to each of the home electronic device and the master electronic device, to the internet through the network device.

10. The home electronic networking system according to claim 9, wherein the setup-information corresponding to each of the home electronic device comprises:
a network address;
a name information;
at least a parameter, configured to describe the status of the home electronic device; and
an operable action.
